(19) United States
(12) Patent Application Publication
(10) Pub. No.: US 2018/0216807 A1
(43) Pub. Date: Aug. 2, 2018

(54) Light-Weight Headlamp

(71) Applicant: E. Mishan & Sons, Inc., New York, NY (US)

(72) Inventor: Edward I. Mishan, New York, NY (US)

(73) Assignee: E. Mishan & Sons, Inc., New York, NY (US)

(21) Appl. No.: 15/418,245

(22) Filed: Jan. 27, 2017

(51) Int. Cl. F21V 21/084; F21V 21/30; F21V 23/02; F21V 23/00; F21V 5/04; F21L 4/06; F21V 31/00

(52) U.S. Cl. CPC F21V 21/084; F21V 21/30; F21V 23/023; F21Y 2115/10; F21V 5/04; F21L 4/06; F21V 31/005; F21V 23/001

(57) ABSTRACT

A light-weight headlamp has a housing containing at least one SMD LED mounted to a circuit board on an inner housing made of thermally non-conductive material fixed to and disposed partly in a pivot mount. The pivot mount is pivotally connected to a mount assembly that is connected by one or more straps to a power source housing containing an electrical power source. The straps hold the mount assembly and power source housing to a users head and a wire connects the power source to the SMD LED. A shield disposed partly in the pivot mount is slidably engaged over the inner housing. A bezel with lens is connected to the shield and changes the shape of a light beam from the SMD LED as the shield slides on the inner housing.

### FIELD AND BACKGROUND OF THE INVENTION

The present invention relates generally to the field of battery powered portable lights, and in particular to a light-weight headlamp for hands-free lighting of an area in front of a wearer of the headlamp.

U.S. Pat. Nos. 7,513,660 and 7,918,578 to Spartano et al. disclose a headlamp having various useful features such and a pivotable light source housing for aiming the beam of light, and a telescopic lens arrangement in the housing for focusing and spreading the beam of light from an LED light source in the housing.

Due to the substantial heat generated by LEDs, these patents also seeks to transfer this heat forwardly and away from the wearer's forehead, by including an internal structure having an inner thermally conductive heat sink in thermal relationship with the LED light source, and an outer heat sink member in thermal heat transfer relationship with the inner heat sink, disposed generally forward of a rear end of the headlamp housing, for directing the heat toward a front end of the housing.

The inner and out heat sinks in these patents are disclosed to be made of thermally conductive material such as aluminum and are distinguished from other internal parts of the headlamp that are made of non-conductive plastic members. While likely effective in channeling the substantial amount of heat generated by LED light sources, forward and thus away for the wearer's head, by using aluminum or other metal parts for their thermal conductivity, this also adds considerable weight to the headlamps of the Spartano et al. patents.

A need remains for an improved and light-weight headlamp.

### SUMMARY OF THE INVENTION

It is an object of the present invention to provide a light-weight headlamp that uses plastic, non-conductive materials in the interior structure of its light source housing, rather than heavier thermally conductive materials, and to combine this with a Surface-Mount Device (SMD) LED light source which generates less heat than conventional LEDs do, to avoid the need for actively conducting heat forwardly away from the wearer's forehead.

These objects are attained while still retaining the advantages of a pivoting and focusing light source beam, but while greatly reducing the weight of the housing. This weight-savings is particularly important in view of the fact that the headlamp is meant to be worn on the user's head, potentially for long periods of time as the user takes advantage of the adjustable, hands-free and bright light source. For example, the headlamp may be used while jogging, walking a dog, hiking or during other activities that may take place during low light conditions.

Accordingly, another object of the invention is to provide a light-weight headlamp that comprises a housing containing at least one SMD LED mounted to a circuit board on an inner housing made of thermally non-conductive material fixed to and disposed partly in a pivot mount. The pivot mount is pivotally connected to a mount assembly that is connected by one or more straps to a power source housing containing an electrical power source. The straps hold the mount assembly and power source housing to a users head and a wire connects the power source to the SMD LED. A shield disposed partly in the pivot mount is slidably engaged over the inner housing. A bezel with lens is connected to the shield and changes the shape of a light beam from the SMD LED as the shield slides on the inner housing.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a perspective view of a light-weight headlamp according to the present invention;

FIG. 2 is an explode view for the headlamp showing its component parts; and

FIG. 3 is a side axial, cross sectional view taken through the light source housing and a mount assembly of the headlamp.

### DESCRIPTION OF THE PREFERRED EMBODIMENTS

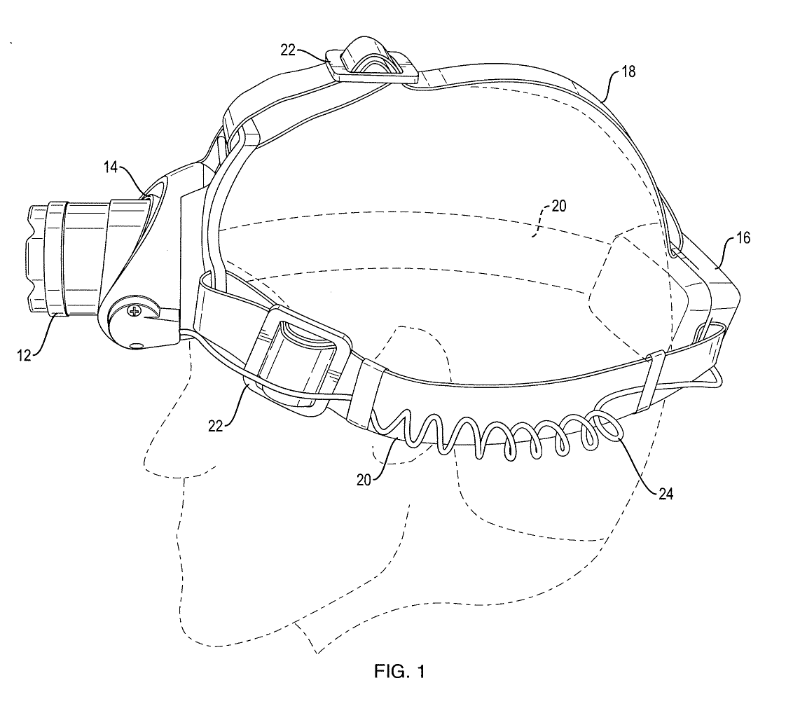

Referring now to the drawings, in which like reference numerals are used to refer to the same or similar elements, FIG. 1 shows a light-weight headlamp of the invention, which includes a light source housing 12 containing at least one SMD LED for generating light when energized, a mount assembly 14 for pivotally carrying the light source housing, a power source housing 16 adapted to containing an electrical power source, at least one, but preferable three strap 18 and 20, connected between the mount assembly 14 and the power source housing 16 and adapted to hold the mount assembly and the power source housing to a users head and a connecting wire 24 for electrically connecting the power source housing 16 to the SMD LED for energizing the SMD LED with electrical power from the power source in the power source housing 16, to generate light.

In a preferred embodiment of the invention, the straps are a cloth and elastic blend so as to be stretchable, with adjusting buckets 22 of plastic to accommodate different size heads, and with one side strap 20 on each side of the user's head and one top strap 18, extending over the top of the user's head. Connecting insulated wire 24 is advantageously partly coiled and extends along one of the side straps 20 to accommodate the size and stretching of the strap 20, without getting tangled or in the way.

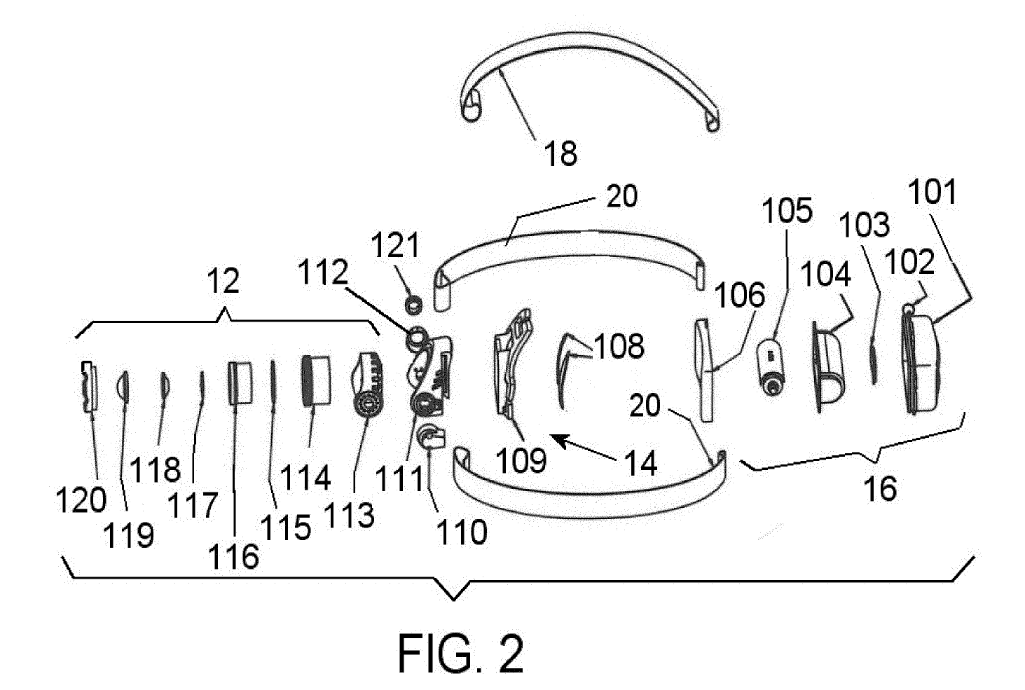

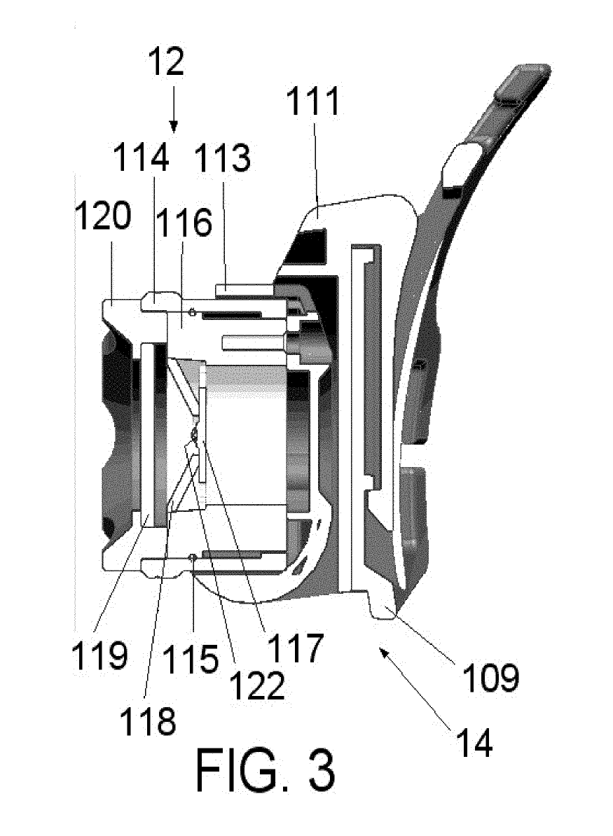

With reference to FIGS. 2 and 3, the light source housing 12 of the headlamp of the invention includes a rear pivot mount 113 of acrylonitrile butadiene styrene (ABS), that is pivotally connected in the volume of a connection part 111 also of ABS, that forms part of the mounting assembly 14. The light source housing 12 also includes an inner cylindrical housing 116 made of thermally non-conductive material such as ABS or other thermally non-conductive, light-weight plastic, and is disposed at least partly in the interior volume of, and having a rear end fixed to, the pivot mount 113, e.g. by screws.

A cylindrical shield 114 disposed at least partly in the interior volume of the pivot mount 113, is slidably engaged over the inner housing 116 so as to slide to the left and right in FIG. 3, to change the shape of a light beam from the SMD LED as will be explained in greater detail later in this disclosure. To act as a frictional resistance and water seal for this sliding motion, so the shield stays in a selected position unless it is pushed or pulled with some force, an O-ring 115 of rubber is captured in an annular groove formed around a forward end of inner housing 116, and an inner surface of shield 114 rides on this O-ring.

This forward end of inner housing 116 is also of a larger diameter than an inner flange inside the rear end of shield 114 so that with the rear end of inner housing 116 fixed, e.g. by screws, to the pivot mount 113, the shield 114 is captured on the inner housing and cannot be pulled from the front end of the inner housing after it reaches its maximum forward sliding position.

A circuit board 117 of aluminum has a front surface to which the

SMD LED 122 is mounted and a rear surface engaged on an interior step in the inner housing 116. A conical reflective, e.g. white, cup 118 of ABS held in a front cylindrical opening of inner housing 116, e.g. by press fit or other means, retains the circuit board 117 in this opening and has a central aperture that received the SMD LED 122 as shown in FIG. 3.

A bezel 120 is connected, e.g. via threads, to a front end of the shield 114 and a lens 119, e.g. of clear acrylic, is fixed in the bezel for focusing light from the SMD LED 122. With the lens 119 closest to the SMD LED 122, a beam of light from this light source will be spread into a conical expanding shape for illumination a large circular area. With the shield 114 and therefore the lens 119 slide away from the SMD LED, the light is focused into a tight column and a generally square illuminated image of the SMD LED creates a small area of intense light.

Pivot mount 113 is pivotally mounted in connector 111 by trunnions with detents extending from the sides of the pivot mount and into openings in either side of the connector 111 so that the housing 12 can be pivoted into several tilted positions to aim the light beam straight ahead or at angles downwardly.

A switch ring 112 mounted at one side of the connector 111 over on of the trunnions, holds a push-button switch 121 to the connected. Switch 121 is electrically connected to the circuit board 117 to power the SMD LED what pressed. A wire cover 110 is connected to an opposite side of connected 111, over the other trunnion, to cover the entry point of wire 24 into the pivot mount 113 and inner housing 116 where it is also connected to the circuit board for cooperating with switch 121 to power the SMD LED 122.

Connector 111 is fixed to a holder 109 that has loop slots to received loops at one end of each of the straps 18, 20 and 20. A pair of foam pads 108 are adhered on a rear surface of holder 109. These are meant to contact the user's forehead and are provided for comfort.

The power source housing 16 comprises a battery case 101 in which a red LED backlight, covered by an LED cover 103, is housed and which is turned on when the SMS LED is powered to be visible at the rear of the case 101 as a safety measure to make the user more visible to others in the dark. An inner battery compartment 104 is fixed in the case 101 and is shaped to receive a battery holder 105 for receiving one or more batteries, in the preferred embodiment, three AAA batteries, that act as an electrical power source for the headlamp.

A metal ring 102 is looped into a hole provided at an edge of case 101, and the ring also loops into a hole in the edge of a rubber battery case cover 106 that covered the front side of the case 101, to keep the cover from being separated from the headlamp.

To lighten the headlamp even further, the shield 114 and the bezel, which can be made of aluminum without adversely effecting the purpose of the invention since little or no heat will be transmitted to these parts from the SMD LED, these parts may alternatively also be made of thermally non-conductive material like the ABS from which the inner housing 116 is made, or other plastic material.

A plurality of circumferentially spaces, radial vent openings through the rear end of the pivot mount 113, allow for cooling air to enter the interior volume of the a light source housing 12 and rush dissipate what little heat is produced by the SMD LED 122.

While a specific embodiment of the invention has been shown and described in detail to illustrate the application of the principles of the invention, it will be understood that the invention may be embodied otherwise without departing from such principles.

What is claimed is:

1. A light-weight headlamp comprising:
a light source housing (12) containing at least one SMD LED (122) for generating light when energized;
a mount assembly (14) for pivotally carrying the light source housing;
a power source housing (16) adapted to containing an electrical power source;
at least one strap (18, 20) connected between the mount assembly (14) and the power source housing (16) and adapted to hold the mount assembly and the power source housing to a users head; and
a connecting wire (24) for electrically connecting the power source housing (16) to the SMD LED for energizing the SMD LED with electrical power from the power source in the power source housing to generate light;
the light source housing (12) comprising:
a rear pivot mount (113) pivotally connected to the mount assembly (14) and defining an interior volume;
an inner housing (116) made of thermally non-conductive material disposed at least partly in the interior volume and having a rear end fixed to the pivot mount (113);
a shield (114) disposed at least partly in the interior volume and slidably engaged over the inner housing (116);
a circuit board (117) having a front surface to which the SMD LED is mounted and a rear surface engaged to a front end of the inner housing (116);
a bezel (120) connected to a front end of the shield (114); and
a lens (120) in the bezel for focusing light from the SMD LED.

2. The light-weight headlamp of claim 1, wherein the bezel is made of thermally non-conductive material.

3. The light-weight headlamp of claim 1, wherein the shield is made of thermally non-conductive material.

4. The light-weight headlamp of claim 1, wherein the bezel is made of thermally non-conductive material in the form of ABS.

5. The light-weight headlamp of claim 1, wherein the shield is made of thermally non-conductive material in the form of ABS.

6. The light-weight headlamp of claim 1, wherein the thermally non-conductive material of the inner housing is ABS.

7. The light-weight headlamp of claim 1, wherein the inner housing and the shield are cylindrical.

8. The light-weight headlamp of claim 1, wherein the inner housing and the shield are cylindrical and are both made of thermally non-conductive material.

9. The light-weight headlamp of claim 1, wherein the inner housing and the shield are cylindrical and are both made of thermally non-conductive material in the form of ABS.

10. A light-weight headlamp comprising:
a light source housing (12) containing at least one SMD LED for generating light when energized, the light source housing (12) comprising: a rear pivot mount (113) defining an interior volume; a cylindrical inner housing (116) made of thermally non-conductive material disposed at least partly in the interior volume and having a rear end fixed to the pivot mount (113); a cylindrical shield (114) disposed at least partly in the interior volume and slidably engaged over the inner housing (116); a circuit board (117) having a front surface to which the SMD LED is mounted and a rear surface engaged to a front end of the inner housing (116); a bezel (120) connected to a front end of the shield (114); and a lens (120) in the bezel for focusing light from the SMD LED;
a mount assembly (14) for pivotally carrying the pivot mount (113) of the and light source housing (12);
a power source housing (16) adapted to containing an electrical power source;
at least one strap (18, 20) connected between the mount assembly (14) and the power source housing (16) and adapted to hold the mount assembly and the power source housing to a users head; and
a connecting wire (24) for electrically connecting the power source housing (16) to the SMD LED for energizing the SMD LED with electrical power from the power source in the power source housing to generate light.

12. The light-weight headlamp of claim 10, wherein the bezel is made of thermally non-conductive material.

13. The light-weight headlamp of claim 10, wherein the shield is made of thermally non-conductive material.

14. The light-weight headlamp of claim 10, wherein the bezel is made of thermally non-conductive material in the form of ABS.

15. The light-weight headlamp of claim 10, wherein the shield is made of thermally non-conductive material in the form of ABS.

16. The light-weight headlamp of claim 10, wherein the thermally non-conductive material of the inner housing is ABS.
